(19) United States
(12) Patent Application Publication
(10) Pub. No.: US 2006/0196487 A1
(43) Pub. Date: Sep. 7, 2006

(54) Fuel control compensation for exhaust sensor response time degradation

(76) Inventors: David N. Belton, Birmingham, MI (US); Igor Anilovich, Walled Lake, MI (US); Julian R. Verdejo, Brighton, MI (US); Richard B. Jess, Haslett, MI (US); John W. Siekkinen, Novi, MI (US); Kevin E. Person, Holly, MI (US); Louis A. Avallone, Linden, MI (US); Thomas C. Pelton, Clarkston, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/285,584

(22) Filed: Nov. 21, 2005

Related U.S. Application Data
(60) Provisional application No. 60/657,997, filed on Mar. 1, 2005.

(51) Int. Cl. F02D 41/14; F02D 41/22

(52) U.S. Cl. 123/688; 123/694

(57) ABSTRACT

A fuel control compensation system for sensor degradation in an exhaust system of a vehicle includes a first module that determines a response time of a signal generated by a sensor of the exhaust system. A second module determines an offset gain based on the response time and a nominal response time. Fuel control of an engine of the vehicle is regulated based on the offset gain.

### CROSS-REFERENCE TO RELATED APPLICATIONS

This application claims the benefit of U.S. Provisional Application No. 60/657,997, filed on Mar. 1, 2005.

### FIELD OF THE INVENTION

The present invention relates to engine control systems, and more particularly to a system that compensates for degradation of exhaust system sensors.

### BACKGROUND OF THE INVENTION

During the combustion process, gasoline is oxidized and as hydrogen (H) and carbon (C) combine with air. Various chemical compounds are formed including carbon dioxide (CO₂), water (H₂O), carbon monoxide (CO), nitrogen oxides (NOₓ), unburned hydrocarbons (HC), sulfur oxides (SOₓ), and other compounds.

Automobile exhaust systems include a catalytic converter that reduces emissions by chemically converting exhaust gas into carbon dioxide (CO₂), nitrogen (N₂), and water (H₂O). Exhaust gas oxygen (O₂) sensors generate signals indicating the oxygen content of the exhaust gas. One O₂ sensor monitors the oxygen level associated with the inlet of the catalytic converter.

The inlet O₂ sensor provides a primary feedback signal to the fuel control system. The signal that is generated by inlet O₂ sensor is used to control the air-to-fuel (A/F) ratio of the engine. Maintaining the A/F ratio at the chemically correct or stoichiometric A/F ratio improves the efficiency of the catalytic converter. A second or outlet O₂ sensor monitors oxygen levels of in the exhaust gas that exits the catalytic converter. The outlet O₂ sensor provides a secondary feedback signal to the fuel system. An optimal control range of the outlet O₂ sensor signal is defined by emission performance. When the outlet O₂ sensor signal is outside of the optimal control range, the fuel control system modifies the fuel adjustments that correspond to the inlet O₂ sensor signal.

Over time, sensor response degrades as a result of exposure to contaminants found in the exhaust. Response degradation can cause the engine control system to incorrectly adjust the A/F ratio. Incorrect adjustment of the A/F ratio can lead to undesired engine performance, which in turn leads to an increase in exhaust emissions.

### SUMMARY OF THE INVENTION

Accordingly, the present invention provides a fuel control compensation system for sensor degradation in an exhaust system of a vehicle. The compensation system includes a first module that determines a response time of a signal generated by a sensor of the exhaust system. A second module determines an offset to the fuel control gains based on the response time and a nominal response time. Fuel control of an engine of the vehicle is regulated based on the gains determined in the second module.

In one feature, the second module compares an actual response time of the signal with a nominal response time to determine whether the signal is degraded.

In another feature, the second module identifies the exhaust sensor as degraded when the response time is above a nominal response time threshold.

In another feature, the second module compensates the fuel control based on a difference between the actual response time and the nominal response time.

In still another feature, the second module compensates the fuel control gains when the signal is degraded.

In yet other features, the second module identifies the exhaust sensor as broken when an actual response time is above an operational threshold. The second module compensates the fuel control based on a default strategy for an exhaust sensor is identified as broken.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of a vehicle including a fuel offset compensating system;

FIG. 2 is a flowchart illustrating steps executed by the degraded signal compensating system according to the present invention;

FIG. 3 is a graph illustrating a relationship between emissions without compensation and reduced emissions with compensation based on response time degradation;

FIG. 4 is a schematic illustration of exemplary modules that execute the degraded signal compensation control of the present invention;

FIG. 5 is an exemplary graph illustrating a normal fuel correction signal based on a normal sensor signal; and

FIG. 6 is an exemplary graph illustrating compensated fuel correction and non-compensated fuel correction for a degraded sensor signal.

### DETAILED DESCRIPTION OF THE PREFERRED EMBODIMENTS

The following description of the preferred embodiments is merely exemplary in nature and is in no way intended to limit the invention, its application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, or other suitable components that provide the described functionality.

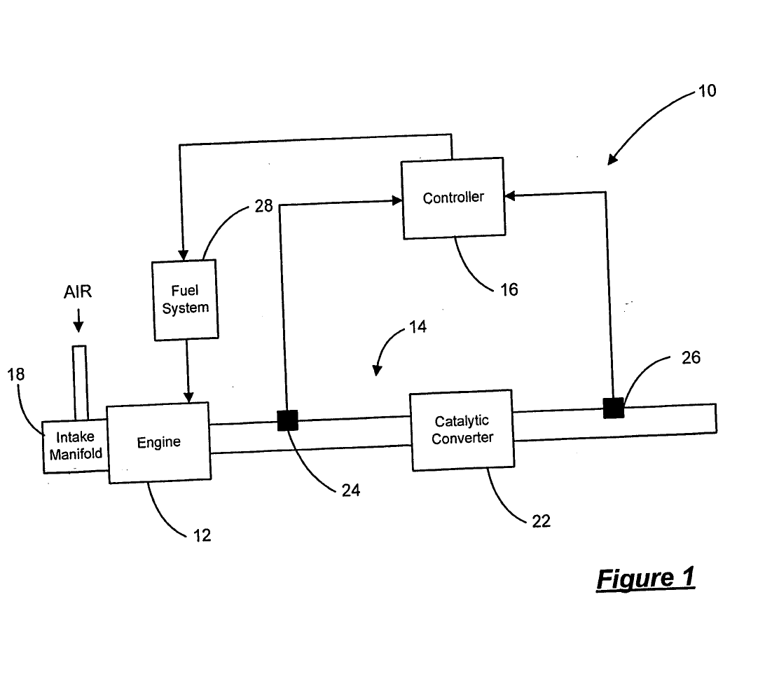

Referring now to FIG. 1, an engine system 10 includes an engine 12, an exhaust system 14 and a control module 16. Air is drawn into the engine through an intake manifold 18. The air is combusted with fuel inside cylinders (not shown) of the engine 12. Exhaust produced by the combustion process exits the engine 12 through the exhaust system 14. The exhaust system 14 includes a catalytic converter 22, a pre-catalyst or inlet O₂ sensor 24 and a post-catalyst or outlet O₂ sensor 26. The exhaust gas is treated in the catalytic converter 22 and is released to atmosphere.

The inlet and outlet O₂ sensors 24, 26 generate signals based on the O₂ content of the exhaust gas. The signals are communicated to the control module 16. The control module 16 determines the A/F ratio based on the signals. The control module 16 communicates with a fuel system 28, which regulates fuel flow to the engine 12. In this manner, the control module 16 adjusts and regulates the A/F ratio to the engine 12.

The inlet and outlet O₂ sensors 24, 26 are typically narrow range switching sensors. It is appreciated, however, that the inlet and outlet O₂ sensors 24, 26 are not limited to narrow range type switching sensors. Voltage output signals that are generated by the sensors 24, 26 are based on the O₂ content of the exhaust passing the O₂ sensors relative to stoichiometry. The signals transition between lean and rich in an A/F ratio range that brackets the stoichiometric A/F ratio. The O₂ sensor signals that are generated by the inlet O₂ sensor 24 oscillates back and forth between rich and lean values.

The control module 16 regulates the fuel flow based on the O₂ sensor signals. For example, if the inlet O₂ sensor signal indicates a lean condition, the control module 16 increases fuel flow to the engine 12. Conversely, if the inlet O₂ sensor signal indicates a rich condition, the control module 16 decreases fuel flow to the engine 12. The amount of fuel is determined based on fuel offset gains, which are determined based on the sensor signals.

The signal compensation system of the present invention compensates for degradation of the inlet O₂ sensor response times to more accurately regulate fuel flow. Degradation of the signal response times can result in the control module 16 improperly regulating fuel to the engine 12. A lean-to-rich (UR) response time and a rich-to-lean (R/L) response time are determined. The UR and R/L response times are compared to respective normal response times and the fuel offset gains (i.e., R/L and UR) are adjusted based on degradation of the signal response time.

The response times can be determined in a number of manners known in the art. In one example, the sensor response times are defined as the amount of time it takes for the sensor to switch from lean to rich and from rich to lean based upon the A/F transition. The control module 16 measures the slopes (e.g., positive and negative slopes) of the O₂ sensor signal within a selected voltage range (e.g., 300 mV to 500 mV). It is appreciated, however, that this range can vary based on system requirements. The slopes are compared to nominal slopes for the particular sensor type to determine response time degradation. Alternatively, and as another example, the response time can be determined based on the instantaneous slope of the sensor signal. This method is disclosed in commonly assigned U.S. patent application Ser. No. 10/624,737, filed on Jul. 22, 2003 and entitled Passive Oxygen Sensor Diagnostic, the disclosure of which is expressly incorporated herein by reference.

It is anticipated that the control module 16 references look-up tables to determine the fuel offset based on the response time. More specifically, the control module determines a response time (t_{RESP}) based on the signal. The control module references a first look-up table if t_{RESP} corresponds to the positive slope and a second look-up table if t_{RESP} corresponds to the negative slope. If t_{RESP} is nominal, the control module 16 determines the fuel offset gain from a first row of the look-up table. For example, if an exemplary t_{RESP} is 55 ms, an exemplary offset gain of 0.2 is determined from the look-up table. If t_{RESP} is not nominal (i.e., degraded), the control module 16 determines a compensated fuel offset gain from an alternative row of the look-up table. For example, if an exemplary degraded t_{RESP} is 70 ms, an exemplary compensated offset gain of 0.25 is determined from the look-up table. In the above example, the offset gain is compensated by 0.5. Additionally, the control module 16 determines whether the O₂ sensor 24 is so degraded that it is considered broken. In this case, a default offset gain is used and a service alert is signalled.

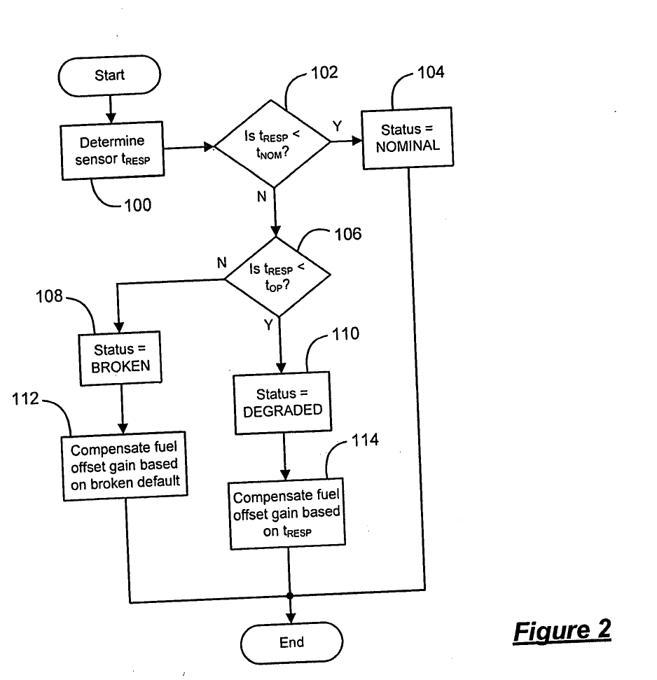

Referring now to FIG. 2, the degraded response time compensation control of the present invention will be described in detail. In step 100, control determines the t_{RESP} of the inlet O₂ sensor 24. In step 102, control compares t_{RESP} to a nominal response time threshold (t_{NOM}). If t_{RESP} is less than t_{NOM}, control sets a status flag to NOMINAL in step 104 and control ends. In this case, the O₂ sensor is operating in the nominal sensor range and no compensation is required. If t_{RESP} is greater than t_{NOM}, control continues in step 106.

In step 106, control compares t_{RESP} to an operational response time threshold (t_{OP}). If t_{RESP} is greater than t_{OP}, control continues in step 108. If t_{RESP} is less than top, control continues in step 110. t_{OP} indicates the point at which the inlet O₂ sensor 24 is considered so degraded or broken that compensation is no longer sufficient and the O₂ sensor 24, should be replaced. In step 108, the status flag is set to BROKEN. In step 112, control compensates the fuel offset gain based on a broken default and control ends. In step 110, control sets the status flag to DEGRADED. Control compensates the fuel offset gain based on t_{RESP} in step 114 and control ends.

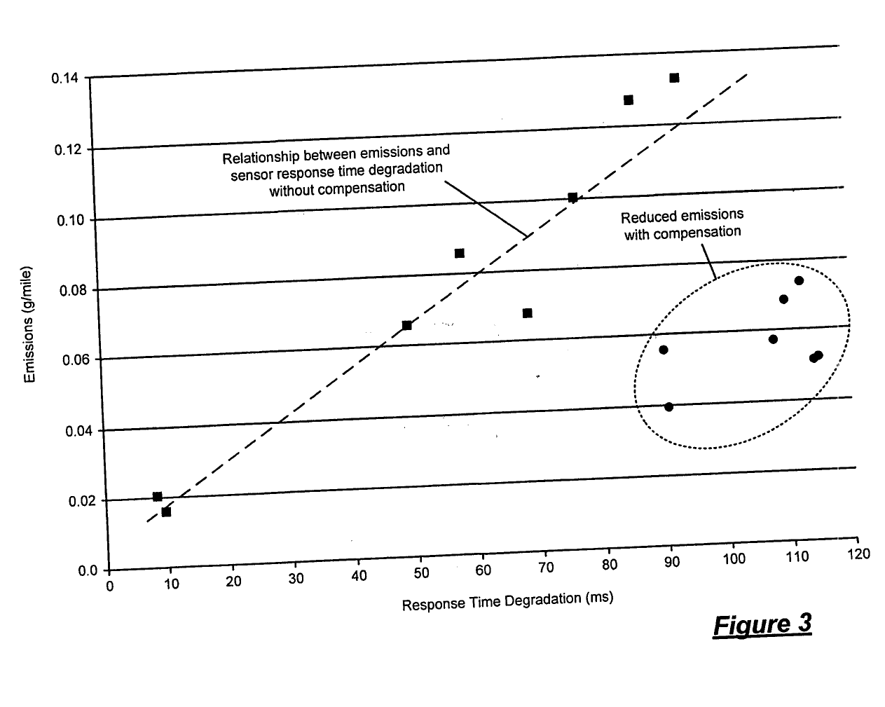

Referring now to FIG. 3, the advantages of the present invention will be discussed. FIG. 3 is a graph that illustrates the relationship between emissions and response time degradation based on exemplary emission data points. As can be seen, emissions increases as the response time degradation increases. FIG. 3 also illustrates exemplary emission data points based on the compensation system of the present invention. As can be seen, the compensated data points provide reduced emissions over the non-compensated.

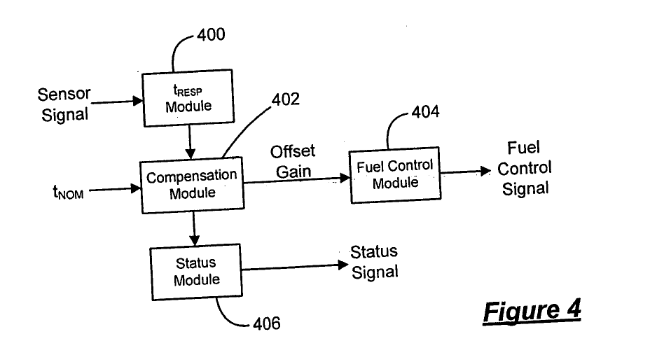

Referring now to FIG. 4, exemplary modules are illustrated, which execute the degraded signal compensation control of the present invention. The exemplary modules include a t_{RESP} module 400, a compensation module 402, a fuel control module 404 and a status module 406. The t_{RESP} module 400 determine t_{RESP} based on the sensor signal. The compensation module determines an offset gain based on t_{RESP} and t_{NOM} and outputs a status indicator to the status module 406. The fuel control module 404 determines a fuel control signal based on the offset gain. The status module 406 determines a status (i.e., NOMINAL, DEGRADED, BROKEN) of the sensor based on the output of the compensation module 402.

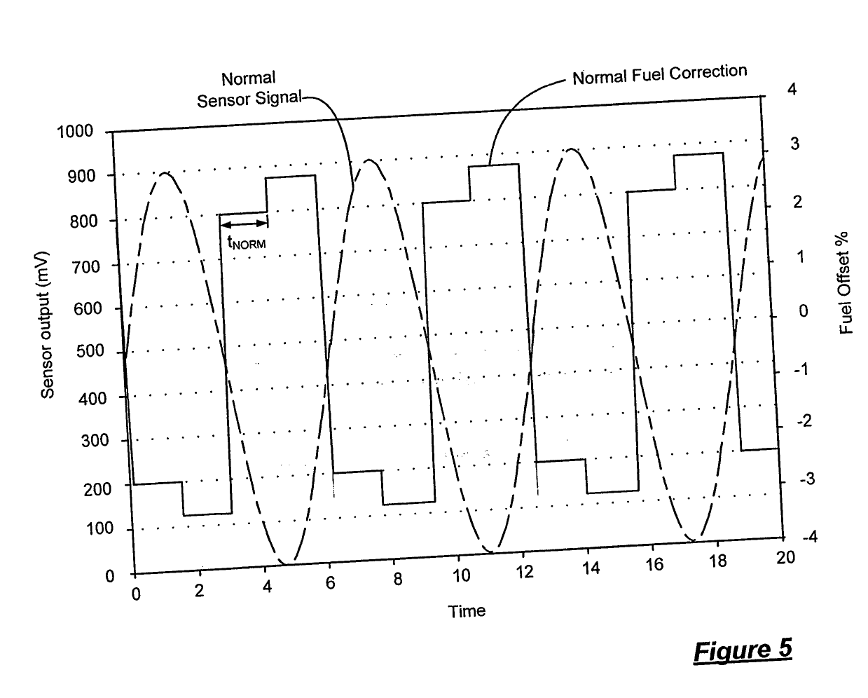

Referring now to FIG. 5, a graph illustrates exemplary fuel correction and normal sensor signals (i.e., no sensor degradation). The fuel correction signal goes to a first level and is increased/decreased to a second level (i.e., integrally stepped) after a normal delay period (t_{NORM}). An exemplary first level is +/−2.5% of the fueling rate. An exemplary second level is +/−3% of the fueling rate to provide an exemplary increase of +/−0.5% of the fueling rate. An exemplary value of t_{NORM} is 1.6 s. Using the exemplary values provided above, the total fuel correction is initially 5% (i.e., +/−2.5%) and steps to 6% (i.e., +/−3%) for a normal sensor signal.

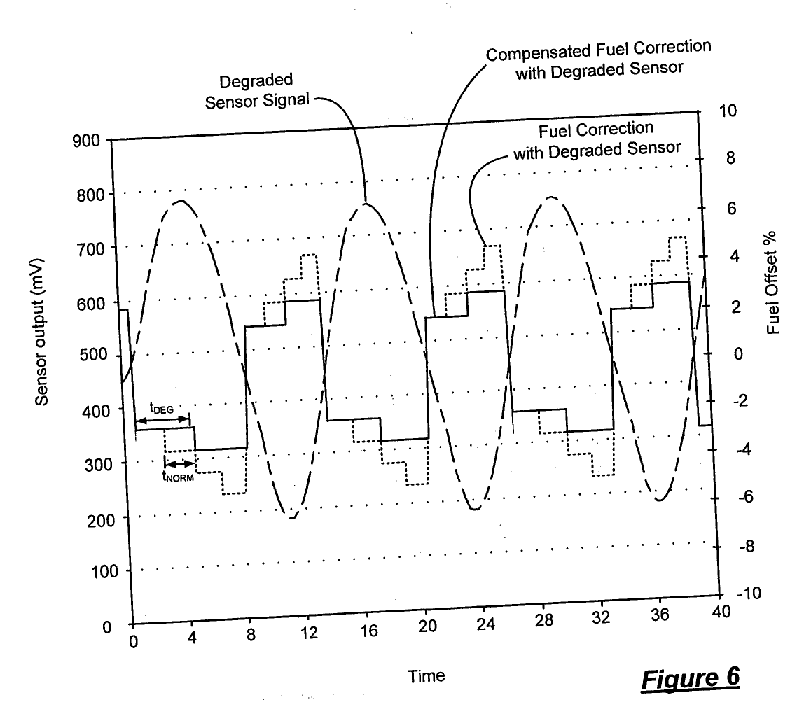

Referring now to FIG. 6, a graph illustrates exemplary compensated fuel correction, non-compensated fuel correction (in phantom) and degraded sensor signals (i.e., sensor response time is degraded). The non-compensated fuel correction signal goes to a first level and is increased/decreased to a second level (i.e., integrally stepped) after a normal delay period (t_{NORM}). An exemplary first level is +/−2.5% of the fueling rate. An exemplary second level is +/−3% of the fueling rate to provide an exemplary increase of +/−0.5% of the fueling rate. An exemplary value of t_{NORM} is 1.6 s. As a result of the degraded sensor, the signal does not transition and the non-compensated fuel correction steps to third and possibly even fourth levels (e.g., 0.5% increases). Using the exemplary values provided above, the total fuel correction is initially 5% (i.e., +/−2.5%) and steps to 8% (i.e., +/−4%) for a degraded sensor signal. Therefore, the total fuel compensation is more than required (e.g., 8% actual>6% required).

The degraded signal compensation of the present invention provides an extended delay period (t_{DEG}) for a degraded sensor condition. The compensated fuel correction signal goes to a first level and is increased/decreased to a second level (i.e., integrally stepped) after t_{DEG}. An exemplary first level is +/−2.5% of the fueling rate. An exemplary second level is +/−3% of the fueling rate to provide an exemplary increase of +/−0.5% of the fueling rate. An exemplary value of t_{DEG} is 3.2 s. As a result, the required fuel compensation (e.g., 6%) is achieved.

Those skilled in the art can now-appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A fuel control compensation system for sensor degradation in an exhaust system of a vehicle, comprising:
a first module that determines a response time of a signal generated by a sensor of said exhaust system; and
a second module that determines an offset gain based on said response time and a nominal response time, wherein fuel control of an engine of said vehicle is regulated based on said offset gain.

2. The fuel control compensation system of claim 1 wherein said second module compares an actual response time of said signal with a nominal response time to determine whether said signal is degraded.

3. The fuel control compensation system of claim 1 wherein said second module identifies said exhaust sensor as degraded when said response time is above a nominal response time threshold.

4. The fuel control compensation system of claim 1 wherein said second module compensates said fuel control based on a difference between said actual response time and said nominal response time.

5. The fuel control compensation system of claim 1 wherein said second module compensates said offset gain when said signal is degraded.

6. The fuel control compensation system of claim 1 wherein said second module identifies said exhaust sensor as broken when an actual response time is above an operational threshold.

7. The fuel control compensation system of claim 6 wherein said second module compensates said offset gain based on a default when said exhaust sensor is identified as broken.

8. A method of compensating fuel control of a vehicle for degradation of an exhaust sensor in an exhaust system, comprising:
monitoring an actual response time of said exhaust sensor;
comparing said actual response time to a nominal response time; and
compensating said fuel control based on a difference between said actual response time and said nominal response time.

9. The method of claim 8 further comprising identifying said exhaust sensor as degraded when said actual response time is above a predetermined value.

10. The method of claim 8 wherein said module compensates a fuel offset when said signal is degraded.

11. The method of claim 8 further comprising identifying said exhaust sensor as broken when said actual response time is above a minimum acceptable operation value.

12. The method of claim 11 further comprising compensating said fuel control based on a default when said exhaust sensor is identified as broken.

13. A method of compensating fuel control of a vehicle for degradation of an exhaust sensor in an exhaust system, comprising:
generating a signal using said exhaust sensor;
determining a response time of said signal;
comparing said response time to a nominal response time threshold;
comparing said response time to an operational response time threshold;
identifying said exhaust sensor as nominal when said response time is below said nominal response time threshold;
identifying said exhaust sensor as broken and compensating said fuel control based on a default compensation factor when said response time exceeds said operational response time threshold.

14. The method of claim 13 further comprising identifying said exhaust sensor as degraded when said response time exceeds said nominal response time threshold.

15. The method of claim 14 further comprising compensating said fuel control based on said response time when said response time exceeds said nominal response time threshold.

16. The method of claim 13 wherein a fuel offset is compensated when said signal is degraded.

17. A fuel control compensation system for oxygen sensor degradation in a vehicle having an exhaust system, comprising:
an exhaust sensor that generates a signal based on an oxygen level of exhaust gas flowing through said vehicle exhaust system; and
a module that regulates fuel control to an engine of said vehicle, that receives said signal, that determines whether said signal is degraded and that compensates said fuel control if said signal is degraded.

18. The fuel control compensation system of claim 17 wherein said module compares an actual response time of said signal with a nominal response time to determine whether said signal is degraded.

19. The fuel control compensation system of claim 17 wherein said module identifies said exhaust sensor as degraded when an actual response time is above a nominal response time threshold.

20. The fuel control compensation system of claim 17 wherein said module compensates said fuel control based on a difference between an actual response time and a nominal response time.

21. The fuel control compensation system of claim 17 wherein said module compensates a fuel offset when said signal is degraded.

22. The fuel control compensation system of claim 17 wherein said module identifies said exhaust sensor as broken when an actual response time is above an operational threshold.

23. The fuel control compensation system of claim 22 wherein said module compensates a fuel offset based on a default when said exhaust sensor is identified as broken.
